(19) United States
(12) Patent Application Publication
(10) Pub. No.: US 2007/0098905 A1
(43) Pub. Date: May 3, 2007

(54) Method for preparing metal oxide layers

(75) Inventors: Manuel Gaudon, Toulouse (FR); Christel Laberty-Robert, L'Union (FR); Florence Ansart, Labege (FR); Philippe Stevens, Karlsruhe (DE)

Correspondence Address: FOLEY & LARDNER LLP, 1530 PAGE MILL ROAD, PALO ALTO, CA, 94304, US

(73) Assignee: ELECTRICITE DE FRANCE SERVICE NATIONAL, CENTRE NATINAL DE LA RECHERCHE (FR)

(21) Appl. No.: 10/561,581

(22) PCT Filed: Jun. 17, 2004
(86) PCT No.: PCT/FR04/50278

§ 371 Date: Dec. 19, 2005

(51) Int. Cl. B01J 23/10; B05D 1/18; B05D 1/12; B05D 3/02

(52) U.S. Cl. 427/376.2; 502/304; 427/430.1; 427/180

(57) ABSTRACT

Method of preparing a metal oxide layer on a substrate, in which the following successive steps are carried out: a) a metal oxide powder is dispersed in a liquid medium comprising a dispersion solvent and a dispersant, the said liquid medium containing neither plasticizer nor binder, by means of which a suspension A of the said metal oxide powder in the said liquid medium is obtained; b) a solution of at least one polymer in a solvent is added to the said suspension A, by means of which a suspension B is obtained; c) suspension B is deposited on the substrate by a dip coating method, by means of which a green layer is obtained; d) the green layer obtained in step c) is dried; and e) the dried layer obtained in step d) is calcined.

The invention relates to a method of preparing metal (metallic elements) oxide layers.

The technical field of the invention may be defined in general as that of the deposition of ceramic layers, in particular thin layers of metal oxides on substrates, especially metal, ceramic or glass substrates, whether dense or porous.

The invention applies in particular to the deposition of dense electrolyte and cathode layers of small thickness, of the mixed oxide type, such as YSZ (yttrium-stabilized zirconia), in SOFCs (solid-oxide fuel cells).

The processes for depositing metal oxide layers may be put into two categories, namely, firstly, dry processing methods and, secondly, wet processing methods.

Thin ceramic films of metal oxides may be prepared by dry processing, especially by plasma methods and vacuum spraying methods.

In plasma methods, a powder is sprayed via a plasma onto a substrate, on which the said powder cools. Films with a maximum thickness of 10 μm are synthesized by these methods. However, further deposition operations have to be carried out in order to reduce the porosity of the film. Another limitation of these methods is that they allow only substrates of simple geometry to be used.

As for vacuum deposition techniques, these require high-performance vacuum systems in order to be able to deposit high-quality films of less than 10 μm. In addition, this expensive technique is also limited by the geometry of the substrate.

Wet processing methods, which allow metal oxide layers of variable thickness to be inexpensively deposited, are essentially chemical methods involving solutions, such as the sol-gel method and the tape casting method.

Sol-gel methods may be divided into three categories: organometallic processing, alkoxide processing and, finally, polymer processing, these differing by the nature of the sol.

One particularly advantageous deposition technique for sols, especially within the context of polymer processing, is the technique called dip coating, which may be briefly divided into four steps: immersion of the substrate in the sol; withdrawal of the substrate from the sol at a controlled rate, causing the layer to be deposited; drainage of the sol from the substrate; and evaporation of the solvent.

However, the sol-gel method used especially via the dip coating technique does not make it possible to produce, in a single step, layers with a thickness of greater than 1 μm.

This is because the conventional sol-gel method generally results in maximum thicknesses of about 100 nm up to 250 nm as a monolayer and consequently it is impossible to obtain oxide layers of greater thickness without carrying out several successive deposition operations. Moreover, the substrate has to undergo several polishing operations in order for the deposition to be carried out satisfactorily.

One of the major limitations of the sol-gel method is that it is difficult to deposit a thin layer on a porous substrate using this method. This is because, if the substrate has an open porosity, during deposition the sol will infiltrate via capillary effect into the pores of the substrate. It is then necessary to carry out a prior treatment on the substrate, for example by applying an intermediate film to the substrate that has to decompose at low temperature and thus allow the thin layer to bond to the substrate.

In the particular case of electrolyte layers for SOFC fuel cells, the inventors have been able to demonstrate that dense, homogeneous, crack-free, covering layers of sufficient thickness, for example made of YSZ, on dense substrates and a fortiori on porous substrates could not be obtained by sol-gel processing.

In other words, it seems that the thicknesses of YSZ layers achieved by sol-gel processing are insufficient to meet the specification of the electrolyte of an SOFC.

In addition, synthesis of a YSZ layer results in heterogeneous crystallization of the oxide at particular sites on the substrate if the latter is dense and of the same nature.

Under such conditions, it turns out to be difficult to obtain dense homogeneous layers, even by carrying out successive deposition operations. The problems that arise are even more acute in the case of a porous substrate, such as one made of Ni—YSZ which is the anode material of currently available SOFCs.

The tape casting method is a recent technology for forming thick layers, used in particular for producing most electrolytes for SOFC fuel cells.

This method requires ceramic powders to be put into suspension in a generally non-aqueous medium which may contain many additives, including dispersion agents, organic binders, and plasticizers.

The key step in this method lies in the preparation of the suspension. This may be likened to a “paste”, it must be homogeneous and highly viscous. It is necessary to add a dispersant in order to stabilize the suspension. In order for this suspension to be able to be deposited easily, it is also necessary to provide it with suitable cohesion and flexibility by the addition of binders and plasticizers. The combination of these constituents forms what is called the tape-casting “slip”. Once the slip has been prepared, it is deposited on a surface by means of a blade, which levels the paste so as to form a “green” film.

The tape casting method has many disadvantages. This is because it is difficult to control the nature and the dosing of the many components of slips. Moreover, it also seems difficult to produce dense homogeneous ceramic films with a thickness of less than around ten μm by this method. Now, in the particular case of fuel cells, it is essential to reduce the thickness of the electrolyte to thicknesses of less than 10 μm so as to lower the operating temperatures of these cells.

Finally, the tape casting method is not very flexible as it is not easily applied to substrates of complex geometry and those possibly with a large surface area.

With regard to the foregoing, there therefore does not exist a method that allows metal oxide layers to be prepared with a variable thickness ranging in particular from 1 μm to several tens of microns, for example up to 200 μm, on any type of substrate.

There is also a need for a simple, reliable and inexpensive method having a limited number of steps, which can be used to prepare high-quality, homogeneous and crack-free layers, films or coatings of controlled porosity, not only on dense but also on porous substrates, it being possible for these substrates to also have a high surface area and/or a complex geometry.

There is also a need for such a method that requires no treatment operation to be carried out on the substrate, especially a porous one, such as a polishing operation or the prior deposition of a priming film.

In particular, there is a need for a method of depositing, preferably in just a single step, metal oxide layers within the 1 to 10 μm thickness range, this thickness range currently not being achievable by the abovementioned techniques for forming thin or thick films, namely the sol-gel technique, for thicknesses below 1 μm, or the tape casting technique, for thicknesses greater than around ten μm.

One goal of the invention is to provide a method of preparing metal oxide layers on a substrate that meets inter alia the above needs.

Another goal of the present invention is to provide a method of preparing metal oxide layers on a substrate that does not have the drawbacks, defects, disadvantages and limitations of the methods of the prior art, and especially the sol-gel methods and the tape-casting methods, and that solves the problems of the methods of the prior art.

These and the other goals are achieved, in accordance with the invention, by a method of preparing a metal oxide layer on a substrate, in which the following successive steps are carried out:
a) a metal oxide powder is dispersed in a liquid medium comprising a dispersion solvent and a dispersant, the said liquid medium containing neither plasticizer nor binder, by means of which a suspension A of the said metal oxide powder in the said liquid medium is obtained;
b) a solution of at least one polymer in a solvent is added to the said suspension A, by means of which a suspension B is obtained;
c) suspension B is deposited on the substrate by a dip coating method, by means of which a green layer is obtained;
d) the green layer obtained in step c) is dried; and
e) the dried layer obtained in step d) is calcined.

The method according to the invention has a specific sequence of specific steps that have never been disclosed in the prior art.

In fact, the method according to the invention comprises, for producing an oxide layer, features both of the dip coating method, using polymer-type sols, and of the tape casting method.

The fact of thus combining features belonging to two fundamentally different methods in order to arrive at the method according to the invention is in itself extremely surprising.

The method according to the invention may in fact be defined as a method intermediate between the sol dip coating method and the tape casting method.

The method according to the invention relies on the production of suspensions, then on the deposition of these suspensions on a substrate using a dip coating technique.

The method according to the invention differs from the sol-gel method in that it involves a suspension of a metal oxide powder in a dispersion solvent that is itself added to a polymer sol and not to a true sol. In this way, a porous substrate can be coated without any difficulty.

Compared with a “tape casting”, the suspension used in the invention overcomes difficulties associated with the use of plasticizers, binders and other additives.

The use of a dip coating method to deposit a suspension is extremely surprising, although it is commonly used for depositing solutions.

The deposition method used according to the invention (dip coating) provides greater flexibility than tape casting and also ensures that coatings of excellent quality are deposited on substrates having a large surface area, for example a surface of 1 cm² to 100 cm², and/or having complex geometries.

The method according to the invention has all the advantages of sol-gel methods and tape-casting methods, without having any of their drawbacks.

The method according to the invention, like sol-gel methods, therefore has the following advantages:
deposition can be carried out on substrates of complex shape and/or large surface area; and
strong adhesion of the layer to the substrate after calcination, because of the decomposition of the polymer contained in the deposited suspension;
   it does not, however, have the drawback of being limited to small layer thicknesses, of less than one micron, and to non-porous substrates.

Likewise, the method according to the invention has, like tape-casting methods, the following advantageous features:
possibility of depositing any metal oxide that can be produced in powder form, on condition that the powder produced can be dispersed in a solution, that is to say that the method according to the invention can be applied to a very large number of oxides; and
possibility of deposition on porous substrates,
   it does not involve plasticizers, binders and other additives and most particularly it does not have the drawback of being limited to thicknesses of greater than around ten μm.

The method according to the invention makes it possible, after step e), that is to say without having to repeat the method and especially steps c) and d) of the method, to prepare layers whose thickness may vary widely, for example from 1 μm to 100 μm, these layers having a controlled porosity, whether on a dense substrate or a porous substrate. One particular benefit of the method of the invention is that it may especially cover the thickness range from 1 μm to 10 μm, which is not achievable by the techniques conventionally used for forming thin or thick films, since the sol-gel technique is used only for preparing layers less than 1 μm in thickness, while tape casting is used only for depositing layers greater than 10 μm in thickness.

The layers prepared by the method according to the invention are of excellent quality and are homogeneous, crack-free and of uniform thickness.

In other words, they possess a completely controlled microstructure, on any type of substrate, whether dense or porous, whether small or large in size, and whether of simple or complex geometry. The films prepared by the method of the invention, owing to their morphological characteristics and their properties, are especially suitable for electrolytes in high-temperature fuel cells or thermal barriers.

The method according to the invention ensures that the microstructure of the film deposited is very precisely controlled in terms of porosity, which may vary between 0 and 30% by volume, grain size, which may vary for example from 50 nm to 5 μm, and specific surface area (the ratio of the actual surface area of the oxide to the geometric surface area of the substrate covered by the coating), which may range from 1 m²/m² to more than 100 m²/m².

Furthermore, unlike the prior art, no prior treatment of the substrate, by polishing or prior film deposition, is necessary and the method is thereby greatly simplified. The method according to the invention uses only a limited number of simple and reliable steps, which results in lower manufacturing costs.

In general, the oxide produced as a layer is chosen from: simple oxides of the transition metals (elements) and lanthanides; mixed oxides of several of these metals (elements); and mixtures of these simple oxides and mixed oxides, depending on the intended application.

One particularly preferred oxide is yttrium-stabilized zerconia of cubic or tetragonal structure.

In general, the dispersion solvent used in step a) is chosen from water, ketones, aliphatic alcohols and mixtures thereof.

One particularly preferred dispersion solvent is an azeotropic mixture of ethanol and methyl ethyl ketone (in proportions of 60/40 by volume).

In general, the content of metal oxide powder in suspension A is 1 to 80% by weight, preferably 20 to 60% by weight, more preferably 30 to 50% by weight and better still 30 to 40% by weight.

The size of the metal oxide powder particles is generally from 5 nm to 5 μm, preferably 100 to 300 nm and better still 50 nm to 300 nm. The size is defined as being the largest dimension of the particle. The particles may have any shape, but preferably the particles of the powder generally have a spherical shape or one that can be likened to a sphere. Their size is therefore defined by the diameter of the sphere.

In general, the dispersant is chosen from ionic surfactants and non-ionic surfactants, such as phosphate esters.

One particularly preferred dispersant is the commercial phosphate ester MELIORAN® PE-312 sold by CECA® S.A.

In general, the mass content of dispersant in suspension A is from 0.1 to 10%, preferably 2 to 3%, by weight, relative to the mass of dry metal oxide powder added.

In general, the polymer in the solution of step b) is chosen from polymers having a long carbon chain or esters. Preferably, this polymer is chosen from aliphatic polyesters.

One particularly preferred polymer is that which can be obtained from the reaction in acid medium, for example in acetic acid, between hexamethylenetetramine and acetylacetone.

In the present invention, one means of determining the polymer content and the length of the polymer chains in the solution in step b) is to carry out measurements of the viscosity of this solution.

The viscosity of the solution may vary from 5 mPa·s to 1000 mPa·s, preferably from 20 mPa·s to 100 mPa·s.

In general, in step b), the polymer solution is added to suspension A in a proportion expressed as a mass ratio (rₘ), namely the ratio mass of polymer solution/mass of dispersion A, of 0.01 to 3, preferably 0.1 to 0.6 and more preferably 0.1 to 0.5.

In the present description, the term “dispersed suspension” denotes a dispersion of a “dry powder” in an aqueous or organic solvent. This means that the powder in the liquid medium is “separated” into individual particles, i.e. there are no aggregates, agglomerates or flocculates.

Moreover, in this description, the term “aggregate” is used to denote a packet of highly compacted individual particles (individual crystallites having common crystal faces) whereas the term “agglomerate” denotes a packet having a lower density (individual particles more weakly bonded together, and having only few atoms in common). Finally, the term “flocculate” denotes a collection of weakly connected particles between which the solvent can insinuate.

The method of the invention will now be described in detail in the following description, given with reference to the appended drawings in which:

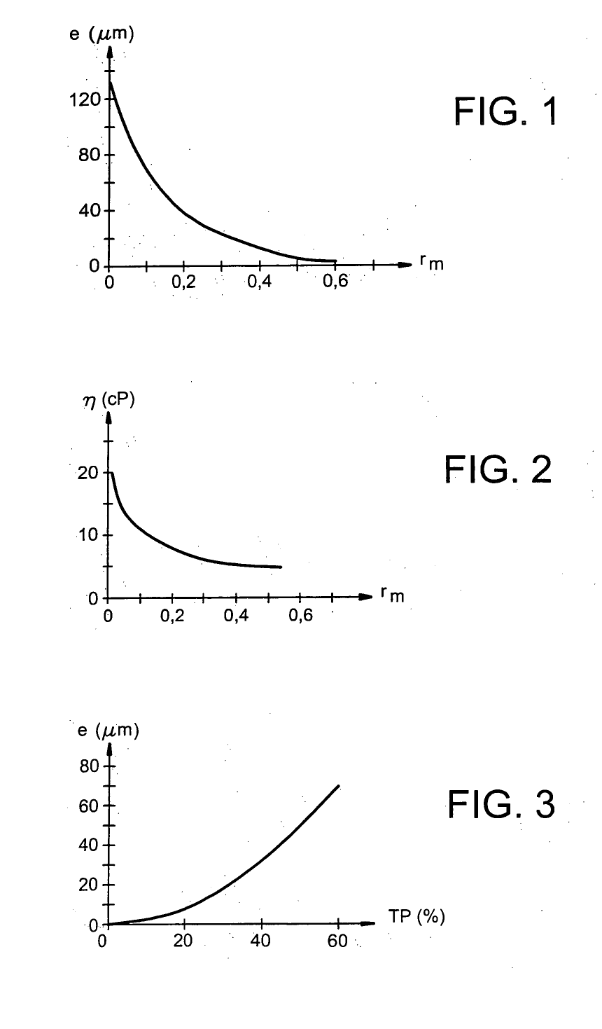

FIG. 1 is a graph giving the variation in thickness “d” (in μm) of YSZ layers prepared by the method of the invention as a function of the suspension ratio rₘ;

FIG. 2 gives the variation in apparent viscosity (in cP) of suspensions B as a function of the ratio rₘ; and

FIG. 3 is a graph giving the thickness “d” (in μm) of YSZ layers deposited by the method of the invention as a function of the powder content PC (in per cent) of suspension B.

In the first step of the method of the invention (step a)), a powder, which is preferably a dry powder, that is to say one whose moisture content is low, for example less than 3% by weight, is dispersed in a dispersion medium comprising an aqueous or organic dispersion solvent.

The separation of the powder into individual particles is carried out in the liquid medium by means of a dispersant. Thus, a suspension A, or prime suspension, of the said powder in the said liquid medium comprising a solvent is obtained.

The intended main application of the invention is the use of the prepared layers as an electrolyte for an SOFC-type fuel cell. Thus, one particularly suitable oxide powder for such a purpose is a powder of yttrium-stabilized zirconia (8 mol % Y₂O₃/ZrO₂) of cubic structure sold by Tosoh® under the brand name T-Z8Y.

T-Z8Y powder consists of individual particles that can be likened to spheres having a diameter of 100 to 200 nm, which are grouped together in more or less spherical agglomerates with a diameter of about 30 to 40 μm. The description that follows will therefore be given most particularly with such a powder, but of course this description can be extended to powders of the same composition but of different morphology that are produced by mild chemistry.

Likewise, the description of the method given below may be extended to any other metal oxide, whether a simple oxide or a mixed oxide, or to a mixture of simple and mixed oxides.

The powder, for example YSZ powder, is dispersed in a liquid medium, which comprises a dispersion solvent and a dispersant but, according to the invention, and unlike tape casting “slips”, it contains neither plasticizer nor binder.

This is because the inventors have shown that layers prepared from suspensions not containing a dispersant are inhomogeneous. It is therefore necessary to introduce a dispersing agent in order to allow better dispersion of the powder in the suspension.

The choice of dispersant depends both on the composition of the oxide to be dispersed and of the solvent. This choice is difficult to make as hitherto no study relating to dispersants in a medium similar to suspension A has been carried out.

The dispersant may in general be chosen from the various ionic or non-ionic surfactants normally used in the preparation of slips.

It has turned out that a commercial phosphate ester, MELIORAN® P312 sold by CECA S.A., is particularly suitable, in particular for dispersing YSZ powders such as the T-Z8Y powder mentioned above, especially in a solvent consisting of an azeotropic mixture of ethanol and methyl ethyl ketone (EtOH/MEK). this is because such a dispersant combines a steric effect with an electrostatic effect, both these preventing the powders from reagglomerating after disintegration of the agglomerates into individual particles during the calcination step.

The dispersion solvent used in step a) for preparing the dispersion may also be chosen from water and organic solvents, such as ketones, aliphatic alcohols and other organic solvents and mixtures thereof.

However, it has turned out that one particularly suitable solvent consists of an azeotropic mixture of ethanol and methyl ethyl ketone (in proportions of 60/40 by volume).

For example, this solvent, using the abovementioned PE-312 as dispersant, makes it possible to obtain a stable and agglomerate-free suspension of the commercial powder T-Z8Y. The high degree of dispersion of the powder obtained according to the invention is manifested by the possibility of introducing a large quantity of powder into the dispersion solvent, namely about 75%, while still maintaining the rheological characteristics of a fluid.

The content of metal oxide powder in suspension A is generally from 1 to 80% by weight and preferably here 20 to 60% by weight.

The mass content of dispersant in suspension A relative to the weight of powder is generally from 0.1 to 10%, preferably 2 to 3%.

The powder may for example be dispersed in suspension A by ultrasonic stirring for a period of a few minutes, for example 10 minutes.

According to an essential feature of the invention, a solution of at least one polymer in a solvent is added to suspension A.

The polymer chains then flocculate the entire dispersed powder so as to form a flocculation network which comprises the polymer chains and the powder and which may also include the dispersant.

Without this polymer solution being added, it is impossible, even in the presence of a dispersant, to obtain a homogeneous and covering film from the suspension, which therefore adheres only very weakly to the substrate. The film deposited therefore mainly consists of the solvent. After annealing, the films obtained are very thin, with a thickness of less than one micron, not very covering and highly inhomogeneous in terms of thickness.

The solution of at least one polymer in a solvent, which is added to suspension A during step b), comprises a solvent chosen from water or various organic solvents, such as alcohols or aliphatic acids or ketones. The preferred solvents are solvents with a low surface tension, thus wetting the substrate really well. A preferred solvent is acetic acid.

The polymer(s) may preferably be chosen from aliphatic polyesters, but other organic polymers may also be suitable.

Another preferred polymer is that which can be obtained from the following polymerizing agents: hexamethylenetetramine (HMTA) and acetylacetone (AcAc) which are preferably present in equimolar proportions.

The polymerization into organic chains takes place via a “hydrolysation” reaction carried out hot, for example at a temperature of 50 to 80° C., and in a moderately acid medium, for example in acetic acid, between the HMTA and ACAC.

To obtain denser oxide layers after calcination, the polymer solution may further contain the same metals as those of the dispersed oxide powder.

For this purpose, salts, such as nitrates and carbonates, of these metals are then added to the polymer solution with a concentration generally between 0.01 and 5 mol/l.

The degree of progress of the polymerization reaction between HMTA and AcAc may be controlled. The polymerizing agent concentration of the solution is generally from 0.01 to 10 mol/l, preferably 0.5 to 1 mol/l.

The viscosity of the polymer solution, which is controlled according to the above parameters, concentration and degree of polymerization of the polymerizing agents, is generally from 1 to 1000 mPa·s, preferably 20 to 100 mPa·s.

The solution or sol containing the polymer is added to suspension A in proportions expressed as the mass ratio rₘ, namely mass of the sol/mass of the solution of dispersion A, this ratio generally varying from 0.01 to 3, preferably 0.1 to 0.6 and more preferably 0.1 to 0.5.

After the polymer solution has been added to suspension A, the mixture may be homogenized by simply stirring it, thus obtaining a suspension B.

The mode of introduction of the constituents of the suspension also constitutes an important feature of the method of the invention. This is because it has turned out that the order of addition of the various constituents has a paramount influence on the homogeneity of suspension B obtained and on the state of dispersion of the powder in this suspension.

Two modes of introduction were thus compared. In the first mode of introduction, a first suspension is produced in which the oxide powder is introduced into a dispersion solvent/polymer solution(sol) mixture whereas in the second mode of introduction, which is in accordance with the invention, a second suspension is produced in which the oxide powder is predispersed in the dispersion solvent before the polymer solution(sol) is added.

These two modes of introduction were tested for various rₘ ratios (0.05, 0.25 and 0.5) of the mass of solution(sol) added to the mass of dispersion solvent (rₘ=mₛₒₗ/m_{dispersion solvent}).

Thus, in the case of the first dispersion mode, the sol and the dispersion solvent are firstly mixed together in the defined proportions (rₘ). The dispersant is then added to this mixture before introduction of the powder.

In the case of the second dispersion mode, the dispersant is mixed only with the dispersant solvent, and then the powder is added. This suspension is ultrasonically stirred for 10 minutes. Finally, the sol is added in the defined proportions (rₘ). The suspension is homogenized simply by stirring it.

The state of dispersion of the powder is characterized by SEM (scanning electron microscopy) analysis on dried samples of suspensions. The micrographs obtained on the samples of the various suspensions produced according to the first mode of introduction are all identical whatever the rₘ ratio, and we will therefore be interested only in a characteristic micrograph, for an rₘ ratio of 0.25.

In contrast, the micrographs obtained on the dried samples of suspensions produced according to the second mode of introduction differ in appearance for the various rₘ ratios.

Comparison between the micrographs shows that the second mode of introduction produces suspensions with a higher degree of dispersion than those obtained by the first mode of introduction.

Specifically, the suspensions resulting from the first mode of introduction exhibit agglomerates with a size of between 20 and 50 μm. In this case, it may be concluded that the dispersion solvent seems to have no beneficial effect.

In contrast, the agglomerates in the suspensions resulting from the second mode of introduction according to the invention are smaller than 20 μm in size, irrespective of the rₘ ratio. In all cases, it seems that most of the powder is dispersed.

Comparison between the state of dispersion of the suspensions resulting from these two modes of introduction reveal a reaction between the sol and the dispersant. Bringing the sol into contact with the dispersant before the powder is introduced seems to eliminate the effect of the dispersant. It is therefore essential that the powder and the dispersant be in contact in a suitable solvent before the polymer chains of the sol are introduced.

The substrate may be of any kind, but in general it is a solid substrate.

For example, it may be chosen from: metal substrates, such as steel, silicon or aluminium substrates; ceramic substrates, such as alumina or yttrium-stabilized zirconia substrates, whether or not doped; glass substrates; and composite substrates formed from two or more of these families of materials.

A preferred substrate within the context of SOFC applications is a porous Ni—YSZ cermet substrate forming, for example, an anode, for example the anode of an SOFC-type fuel cell.

The substrates used according to the invention do not have to undergo a treatment prior to deposition of the suspension, whether this be a polishing operation or deposition of a film or the like, and it is this that is one of the advantages of the method of the invention.

The substrate may be porous or fully dense. In the latter case, it may especially be a refractory oxide substrate.

If the substrate is a porous substrate, it may have an open and/or closed porosity possibly ranging for example up to 50% by volume. This is one of the other advantages of the method of the invention, which provides homogeneous oxide layers of excellent quality on both types of substrate. As examples of dense substrates, we cite for example YSZ polycrystalline substrates. As porous substrates, we cite the abovementioned Ni—YSZ cermet.

The thickness may also be controlled by varying the rate of withdrawal of the substrate from suspension B (step 2 of the coating method). In general, this rate may vary between 0.1 and 100 cm/min and preferably between 1 and 10 cm/min. In the experiments that will follow, the rate of withdrawal is constant and set at 1.4 cm/min.

In a first study, layers were deposited on a dense YSZ substrate.

It was firstly shown that the above rₘ ratio has a considerable influence on the properties of the final oxide layers obtained. In order to study just the influence of the relative amounts of sol and dispersion solvent on the morphology of the layers resulting from dispersions, these layers were synthesized for various rₘ values, whereas the other synthesis parameters were kept constant, for example the powder content was kept equal to 50% for all rₘ ratios. The morphology of the layers resulting from the suspensions, in terms of their thickness, coverage of the substrate, presence of agglomerates, density, etc., was carried out by scanning electron microscopy.

The micrographs show that, irrespective of the rₘ ratio, the films obtained are continuous and homogeneous and that the higher the rₘ ratio in the suspensions the larger the number of cracks on the surface of the layers. This is the reason why it is generally preferably to be limited to an rₘ of 0.6.

With respect to the thickness of the layers, the micrographs show that while still keeping the powder content of the suspensions constant, controlling the rₘ ratio of the suspension makes it possible to obtain layers whose thickness varies over a wide range: a layer of about 80 μm in thickness is obtained for an rₘ ratio of 0.05, whereas a layer of only 7-8 μm in thickness is obtained for an rₘ ratio of 0.5. The rₘ ratio therefore has a very strong influence on the thickness of the layers. The variation in layer thickness (in μm) as a function of the rₘ ratio of the suspensions (0≦rₘ≦0.6) is shown in FIG. 1.

FIG. 1 shows an asymptotic decrease in the thickness of the YSZ layers with the rₘ ratio. However, for an rₘ value of 0, which corresponds to a suspension with no polymer, the layers are inhomogeneous and their thickness is very small (a thickness of about one micron), which shows the importance of the addition, according to the invention, of a polymer sol.

As regards the density of the layers after calcination at 1000° C. for 2 h, the micrographs of the layers show that the thinnest layers are of low density.

The thinnest layers are those resulting from suspensions with the highest rₘ ratios, that is to say from suspensions having the largest number of polymer chains. It may be concluded from this that the porosity is mainly due to the composition of the polymer chains of the suspensions, and not of the dispersion solvent.

It follows from the foregoing that, by controlling the amount of polymer solution added to the suspensions, it is possible to control the thickness of the layers produced over a wide range and also, to a lesser extent, their density. This is because the rₘ ratio has a very strong influence on the rheology of the suspensions and therefore on the thickness of the layers.

The variation in thickness of the layers resulting from suspensions having different rₘ ratios correlated with the variation in apparent viscosity of these suspensions. Specifically, via the coating method employed, it is clear that the viscosity of the suspensions also exerts a certain influence on the morphology of the thin layers formed by the method of the invention. FIG. 2 shows the variation in apparent viscosity η (in mPa·s) of suspensions B as a function of the rₘ ratio.

The viscosity of a suspension containing no sol is very low, less than 5 mPa·s. The addition of sol to the suspension firstly causes a sudden increase in the apparent viscosity, which then decreases asymptotically with the rₘ ratio.

The variation in viscosity of the suspensions as a function of the rₘ ratio therefore is very similar to the variation in thickness of the layers as a function of this same ratio since in both cases the observed decrease follows an asymptotic function.

Moreover, to explain the variation in viscosity of the suspensions as a function of the rₘ ratio, the rheology of these suspensions was studied and, at the same time, with the same objective in mind, sedimentation tests were carried out on the suspensions.

From the sedimentation studies carried out, it appears that the addition of sol to the suspensions brings about not reagglomeration of part of the powder but flocculation of the latter with the solvent. In addition, the sharpness of the sedimentation front, due to the complete absence of powder in the supernatant solvent, this being so throughout the sedimentation, tends to show that all the powder particles are flocculated, and not agglomerated into entities of variable size. This is because, if the addition of sol had only caused the powder to agglomerate, it would be impossible to interpret the immediate formation of the perfectly defined sedimentation front except in the case of highly homogeneous agglomerates. All the powder in these suspensions therefore flocculates, probably simultaneously with the introduction of the sol into the suspensions.

Moreover, in these suspensions, the increase in sediment volume with the rₘ ratio testifies to it being the sol, as opposed to the solvent, such as EtOH/MEK, that is predominantly present in the flocculates and therefore that, probably, it is the polymer chains which participate in the formation of the flocculates. What we have is a continuous network consisting of powder and polymer chains. Thus, under the effect of gravity, it therefore seems that it is this entire network that sediments, to give the final sediment. Now, the higher the rₘ ratio, the higher the ratio of the number of polymer chains to the number of solid particles participating in the network. A reduction in density of the sediment is therefore observed with an increase in the rₘ ratio.

It is very interesting to note that the possibility of depositing thick films from such suspensions very certainly stems from the coherence of the network formed by the polymer chains of the sol and the powder particles. This shows that, in suspension B used in the method of the invention, a true synergy exists between the metal oxide powder and the polymer of the sol.

In addition, the formation of such a network explains the reduction in density of the layers obtained when the rₘ ratio increases since, after drying, the coating deposited may be likened to a thin layer of this network. It is therefore certain that the porosity of the final oxide layer is due to the decomposition of the polymer chains of the sol during the calcination step. Thus, for high rₘ ratios, the networks containing a large amount of sol result, after calcination, in porous layers.

However, it would also seem that a chemical reaction can take place between the dispersant and the sol. This would partly explain the ineffectiveness of the dispersant when the latter is added to the sol before the introduction of the powder, according to an operating mode contrary to that of the invention.

Without wishing to be tied down by any theory, the sedimentation and rheology experiments and a study of the laws governing the behaviour of suspensions make it possible to propose the hypothesis that the strong influence of the amount of sol on the state of dispersion of the suspended powder is due to two phenomena. Firstly, it is due to the formation of a coherent network between the polymer chains of the sol and the powder and, secondly, to the relatively great flexibility of the network formed. The latter parameter seems to depend on the ratio of the number of polymer chains to the number of powder particles constituting the network.

It was seen earlier that the thickness of the layers produced can be controlled by varying the amount of the sol added to suspensions A, but the thickness may also be controlled by modifying other suspension synthesis parameters, and especially the powder content in suspensions B.

Thus, YSZ layers were prepared from suspensions having a constant rₘ ratio of 0.25 and various powder contents, namely 20%, 35% and 60%. The various layers obtained were observed by scanning electron microscopy and the thickness of the layers was calculated from the micrographs of sections through the layers with an estimated error of 2 μm.

For powder contents of less than 20%, the layers generally do not cover the entire substrate.

In FIG. 3, the thickness of the layers (in μm) varies as a function of the powder content of suspension B according to a power law, with a coefficient of about 1.8. This variation, unlike the case of layers resulting from a conventional sol-gel method, is therefore not a linear function of the oxide content in the precursor medium. As in the previous study (thickness of the layers controlled by the rₘ ratio of the suspensions), the variation in thickness of the layers can be correlated with the variation in viscosity of the suspensions.

The suspension B was deposited on the substrate by a dip coating method. The dip coating method generally comprises five steps. In a first step, the substrate is immersed or dipped into suspension B. After complete immersion of the substrate in the suspension, it is withdrawn from suspension B at a controlled rate, this controlled rate generally being, according to the invention, from 0.1 to 100 cm/min, preferably 1 to 10 cm/min.

During this withdrawal step, it is the competition between the force of gravity, the viscosity and the surface tension of the sol that determines the geometry of the concave meniscus at the substrate/liquid interface, on which the thickness of the deposited film depends. The film deposited then thins under the combined effect of gravity and evaporation of the solvent. The latter two steps are competitive and simultaneous.

The dip coating step may be carried out in any apparatus or set-up suitable for this purpose.

In a second study, the method developed for a dense substrate was transferred to porous substrates, namely Ni—YSZ cermets. Attempts at depositing sols on such substrates showed that the sols resulting from the direct sol-gel technique filtrated by capillary effect into the pores of the substrate. In contrast, the trials carried out on films deposited according to the invention from suspensions show that the powder of the suspensions does not infiltrate into the pores of the substrates. It therefore appears to be easier to obtain films on porous substrates using suspensions.

As previously on dense substrates, the films are deposited firstly from suspensions of variable rₘ ratio for constant powder contents, and then, secondly, from suspensions of variable powder content for constant rₘ ratios. The results obtained on porous Ni—YSZ substrates may be compared directly with those on dense YSZ substrates.

The first series of experiments was carried out using suspensions whose rₘ radio varied from 0.08 to 0.5 with a constant powder content of 50%, that is to say under conditions similar to the study of the dense substrate. Micrographs of the layers obtained for extreme rₘ ratios of 0.08 and 0.5 were taken.

It was noticed that the thicknesses obtained on a porous substrate were much greater than on a dense substrate, for any value of rₘ.

In the second series of experiments, for a constant rₘ ratio (rₘ=0.25), layers resulting from suspensions having different powder contents (between 15 and 50%) were produced.

A micrograph corresponding to a suspension with a powder content of 35% shows that, for this content, the layer starts to crack.

Not only are the layers obtained on a porous substrate thicker than those obtained on a dense substrate, but also the variation in thickness as a function of the powder content of the suspensions is more rapid. This variation may be described by a power law with a coefficient of about 2.3.

From this it may be concluded that the method of depositing the suspensions can be transferred successfully from dense substrates to porous substrates. As we demonstrated on a dense substrate, the thickness of the layers increases proportionally with the powder content and inversely proportionally with the rₘ ratio. However, the layers obtained on a porous substrate are of greater thickness than that obtained on a dense substrate. This phenomenon must be due to an additional interaction between the suspension and the porous substrate during deposition. The porosity of the substrate must therefore be taken into account in describing the phenomena governing the deposition since, on a porous substrate, the deposited thickness can no longer be directly related to the viscosity of the suspension.

The method according to the invention makes it possible, unlike the thick deposition method, to coat substrates of large surface area, that is to say having a surface area of 1 to several tens of cm², and/or of complex geometry, for example substrates in the form of tubes or other three-dimensional objects.

After suspension B has been deposited on the substrate (in step c)), the green layer obtained is dried.

The drying is generally carried out at a temperature ranging from room temperature to 150° C., preferably from room temperature to 50° C. The drying may be carried out in the open air, in an oven or in a covered crystallizer. Depending on the temperature and the atmosphere in which the drying is carried out, the rate and duration of drying vary. In general, this duration is for example from a few minutes to several hours, preferably from 1 minute to 10 hours and more preferably about 1 h.

It has been shown on micrographs of layers dried at various rates that the number of cracks on the surface of the layers increases with the drying rate. The morphology of the cracks also depends on the drying method. This is because, when the drying rate decreases the cracks become not only shorter but also less open. In view of these experiments, it may be considered that the drying step is the determining step with respect to cracking of the layers obtained from suspensions. As a consequence, the drying is preferably carried out at room temperature in a controlled atmosphere and its duration is about 1 hour.

After drying, the “green” dried layer obtained is annealed by high-temperature calcination in order to form the final oxide layer. The temperature used in this step must be above the decomposition temperature of all the organic compounds in the suspension. The calcination temperature will therefore generally be from 200° C. to 1800° C., preferably 400 to 1800° C. and even more preferably 1000° C. to 1400° C., this calcination temperature being maintained or applied for a time generally ranging from a few seconds, for example 2 seconds to several hours, preferably 1 to 10 hours.

The calcination temperature is reached from room temperature by observing a rate of increase of generally from 0.1 to 100° C./min, preferably 1 to 10° C./min.

If T-Z8Y powder, described above, is used to deposit a YZS layer on a substrate, which is for example an Ni—YSZ cermet, the powder having been produced at 1000° C., the layers prepared with this powder and having been annealed at this temperature, may be termed “green” layers.

It has been shown that a temperature of 1300° C. could be applied to porous substrates of the Ni—YSZ cermet type without thereby modifying their porosity. The calcination treatment may therefore be carried out on the YSZ layer deposited on this substrate at a temperature of 1300° C. for a time of several hours, for example 2 hours.

It is also possible during the final calcination step to cosinter, that is to simultaneously sinter, the metal oxide layer and the substrate. Such cosintering may in particular prove to be advantageous when it is desired to produce a dense layer on a porous substrate, for example an electrolyte layer, such as a YSZ layer, on a porous substrate, for example an Ni—YSZ anode. In order for it to be possible to cosinter the thin porous electrolyte oxide layer and the substrate, it is preferable for these two components to have similar sintering temperatures and close thermal expansion coefficients. This is specifically the case for anode and electrolyte materials such as Ni—YSZ cermet and YSZ, respectively, the sintering of which may be carried out generally at a temperature of 800 to 1500° C., for example 1200° C.

The invention will now be described with reference to the following examples, given by way of illustration but implying no limitation.

### EXAMPLE 1

In this example, a thin layer of yttria-stabilized zirconia was produced on dense yttria-stabilized zirconia substrate:
a) Preparation of an yttria-stabilized zirconia powder suspension:
100 ml of a mixture of solvents, namely ethanol (EtOH) and methyl ethyl ketone (MEK) comprising 60 ml of EtOH and 40 ml of MEK, were prepared;
50 g of this mixture were taken.

Next, 125 mg of a dispersing agent, namely the commercial phosphate ester MELIORAN® P-312, were added to the mixture. The dispersant was then dissolved and the solution homogenized. Added to this solution were 50 g of Tosoh T-8YSZ commercial yttria-stabilized zirconia powder. The powder was dispersed for 5 minutes using ultrasound. A homogeneous prime suspension A was thus obtained.
b) Preparation of a polymer sol:
Acetylacetone (AcAc) and hexamethylenetetramine (HMTA) were dissolved in equimolar proportions in acetic acid. The concentration of this AcAc/HMTA solution was 0.625M.

The solution was heated on a hotplate to a temperature of about 80° C. This step was prolonged until a viscous polymer sol with a viscosity of about 60 mPa·s was obtained.
c) Preparation of the suspension for deposition:
10 g of the polymer sol prepared at b) were added to 50 g of suspension A. The polymeric suspension obtained was homogenized.
   d) Preparation of the layer:
A dense yttria-stabilized zirconia substrate was immersed in the suspension prepared in step c) and then withdrawn at a rate of 1.4 cm/min. The layer was dried at room temperature in air. The layer was then calcined at a temperature of 1300° C.

Thus, a dense layer of about 40 microns in thickness was obtained.

### EXAMPLE 2

In this example, a thin yttria-stabilized zirconia layer was produced on a porous substrate.

The operating method was in the same as in Example 1, except for the fact that an Ni—YSZ porous substrate, the diameter of the pores varying from 200 nm to 5 microns, was used.

A dense layer of about 100 microns in thickness was obtained.

Both in Example 1 and Example 2, the thickness was measured by scanning electron microscopy. The layers prepared in both examples were homogeneous in terms of thickness and had no cracks.

1. A method of preparing a metal oxide layer on a substrate, in which the following successive steps are carried out:
a) a metal oxide powder is dispersed in a liquid medium comprising a dispersion solvent and a dispersant, the said liquid medium containing neither plasticizer nor binder, by means of which a suspension A of the said metal oxide powder in the said liquid medium is obtained;
b) a solution of at least one polymer in a solvent is added to the said suspension A, by means of which a suspension B is obtained;
c) suspension B is deposited on the substrate by a dip coating method, by means of which a green layer is obtained;
d) the green layer obtained in step c) is dried; and
e) the dried layer obtained in step d) is calcined.

2. The method according to claim 1, in which the metal oxide layer obtained after step e) has a thickness of 1 to 100 μm.

3. The method according to claim 2, in which the metal oxide layer obtained after step e) has a thickness of 1 to 10 μm.

4. The method according to claim 1, in which the metal oxide is chosen from: simple oxides of the transition metals and lanthanides; mixed oxides of several of these metals; and mixtures of these simple oxides and mixed oxides.

5. The method according to claim 1, in which the metal oxide is yttrium-stabilized zirconia of cubic or tetragonal structure.

6. The method according to claim 1, in which the dispersion solvent is chosen from water, ketones, aliphatic alcohols and mixtures thereof.

7. The method according to claim 6, in which the dispersion solvent is an azeotropic mixture of ethanol and methyl ethyl ketone.

8. The method according to claim 1, in which the content of metal oxide powder in suspension A is 1 to 80% by weight, preferably 20 to 60% by weight, more preferably 30 to 50% by weight, and still more preferably 30 to 40% by weight.

9. The method according to claim 1, in which the metal oxide powder particles have a size of 5 nm to 5 μm, preferably 100 to 300 nm and better still 50 to 300 nm.

10. The method according to claim 1, in which the dispersant is chosen from ionic surfactants and non-ionic surfactants, such as phosphate esters.

11. The method according to claim 10, in which the dispersant is the phosphate ester MELIORAN®.

12. The method according to claim 1, in which the mass content of dispersant in suspension A is from 0.1 to 10% by weight, preferably 2 to 3% by weight, relative to the mass of dry metal oxide powder added.

13. The method according to claim 1, in which the polymer is chosen from poly(aliphatic)esters.

14. The method according to claim 1, in which the polymer is a polymer obtainable from the reaction between hexamethylenetetramine and acetylacetone in acid medium, for example in acetic acid.

15. The method according to claim 1, in which the solution of at least one polymer of step b) furthermore contains the same metals as those of the oxide powder.

16. The method according to claim 1, in which the solution of step b) has a viscosity of 5 mPa·s to 1000 mPa·s, preferably 20 to 100 mPa·s.

17. The method according to claim 1, in which, in step b), the polymer solution is added to suspension A in a proportion expressed as a mass ratio (rₘ), namely the ratio mass of polymer solution/mass of dispersion A, of 0.01 to 3, preferably 0.1 to 0.6 and more preferably 0.1 to 0.5.

18. The method according to claim 1, in which the dip coating method of step c) includes a step of removing the substrate from suspension B at a controlled rate of 0.1 to 100 cm/min, preferably 1 to 10 cm/min.

19. The method according to claim 1, in which the drying is carried out at a temperature ranging from room temperature to 150° C., preferably from room temperature to 50° C.

20. The method according to claim 19, in which the drying time is from 1 min to 10 h, preferably about 1 h.

21. The method according to claim 1, in which the calcination of step e) is carried out at a calcination temperature of 200 to 1800° C., preferably 400 to 1800° C. and more preferably 1000 to 1400° C.

22. The method according to claim 21, in which the calcination temperature is reached, starting from room temperature, at a rate of increase of 0.1 to 100° C./min, preferably 1 to 10° C./min.

23. The method according to claim 21, in which the calcination temperature is maintained for a time of a few seconds, for example 2 seconds to several hours, preferably 1 to 10 h.

24. The method according to claim 1, in which, in step e), the metal oxide layer and the substrate undergo a simultaneous sintering, or cosintering, operation.

25. The method according to claim 1, in which the substrate is a fully dense substrate, for example a refractory oxide substrate.

26. The method according to claim 1, in which the substrate is a porous substrate having an open and/or closed porosity ranging up to 50% by volume.

27. The method according to claim 1, in which the substrate is chosen from: metal substrates, such as steel, silicon or aluminium substrates; ceramic substrates, such as alumina or yttrium-stabilized zirconia substrates, whether or not doped; glass substrates; and composite substrates formed from two or more of these families of materials.

28. The method according to claim 27, in which the substrate is a porous Ni—YSZ cermet substrate forming for example an anode, for example of an SOFC fuel cell.
